(19) United States
(12) Patent Application Publication
(10) Pub. No.: US 2013/0282323 A1
(43) Pub. Date: Oct. 24, 2013

(54) Visual dynamic monitoring system for operating states of protective relay system

(71) Applicant: Xiang Gao, Shanghai (CN)

(72) Inventor: Xiang Gao, Shanghai (CN)

(73) Assignee: Shanghai Yihao Automatic Co., Ltd.

(21) Appl. No.: 13/547,079

(22) Filed: Jul. 12, 2012

(30) Foreign Application Priority Data
Apr. 24, 2012 (CN) 201210122549.9

(51) Int. Cl. H01H 71/04; G06F 19/00

(52) U.S. Cl. 702/117

(57) ABSTRACT

A visual dynamic monitoring system for operating states of a protective relay system, which is applied to a computer based relay includes: collecting information of a voltage input circuit & a current input circuit and internal hardware & software of protection relay, as well as a tripping and closing circuit, to obtain real-time informations completely reflecting operating states of the protective relay system; analytically calculating the real-time information mentioned above according to the designed protection principle, forming logical relations having a time sequential characteristic among the real-time information with a result by the analytically calculating; and dynamically displaying the operating states of the protective relay system, so as to providing a supporting data for implementing an evaluation of the operating states of the protective relay system.

### BACKGROUND OF THE PRESENT INVENTION

1. Field of Invention

The present invention relates to a technical field of a power system, and more particularly to a visual dynamic monitoring system for operating states of a protective relay system.

2. Description of Related Arts

The rapid development of techniques in industries such as micro-electronics, computers and communications provides a basis for the application of a microcomputer-based protective relay device in a power system. The microcomputer-based protective relay plays a vital role for the stability of a power system. Hence the performance of a relay has critical effects on the safety and stability of the power system.

The application of computer-based relay brings benefits for easy detecting the default of relays. However, an operation principle that a computer-based relay responding to a power system disturbance based on a digital signal processing technique turns a visible logic schematic view of an original static relay into a black box. Furthermore information reflecting the computer-based relay performance is in a manner of an events report instead of a visual sequential logic. From practical point of view, the computer-based relay causes some inconvenience for the behavior analysis of relays in a situation of a power system disturbance.

In addition, a protective relay system comprises a current input circuit, a voltage input circuit, a relay, a tripping and closing circuit, and etc. A problem at any components may cause a protective relay to operate improperly. In fact, the computer-based relay has a self-detection capability which covers only 70-80% of the relay itself.

Therefore, the acquisition of characteristic parameters which cover the whole protective relay system is helpful to deduce the health condition-of a protective relay system based on the information of relay internal logic as well as a secondary circuit.

It is possible to realize a visual real-time dynamic representation of the relay operation principle, rather than a non-transparent black box. Furthermore, it may improve the reliability of a protective relay system as the first safety defense of the power system, and control the operation risks of the power system. Meanwhile, it may provide technical support for reliability evaluation and state-based maintenance of the relay system.

### SUMMARY OF THE PRESENT INVENTION

In view of the descriptions mentioned above, a visual dynamic monitoring method for operating states of a protective relay system is provided according to a preferred embodiment of the present invention, comprising:

obtaining real-time information reflecting operation states of a protective relay system, by extracting characteristic information of internal basic elements of a computer-based relay and characteristic information of a secondary circuit related;

analytically calculating the real-time information mentioned above according to a designed protection principle, and forming logical relations concerned a time sequential characteristic among the real-time information based on a process control principle;

visually displaying the operation state of the protective relay system.

In such a manner, technicians are capable of visually observing real-time the behavior of a protective relay system, and accordingly, judging whether the response characteristic of a protective relay system satisfies the designed principle, so as to provide critical technical supporting for implementing of condition based maintenance of protective relay system, and automatic processing analysis in a power system disturbance. And man-made mistakes may be able decreased significantly.

A visual dynamic monitoring method for operating states of the protective relay system, which is applied to computer based relays, comprises:

collecting information of a voltage input circuit and current input circuit of the protective relay system, internal information of a relay concerned hardware & software, as well as information of a tripping and closing circuit, to obtain real-time information completely reflecting operating states of the protective relay system;

analytically calculating the above mentioned real-time information, based on the designed protection principle, and forming logical relations having a time sequential characteristic among the real-time information;

visually displaying the dynamic states of the protective relay system to provide a supporting data for implementing an evaluation of the operating states of the protective relay system.

Particularly, the information of the voltage input circuit & the current input circuit of the protective relay system, the internal information of the relay device, and the tripping and closing circuit, which are collected, are combined into real-time information reflecting the operating states of the protective relay system completely;

Particularly, according to the designed protection principle, the real-time information which reflects operating conditions of the protective relay system completely are analytically calculated, and logical relations having a time sequential characteristic among the real-time information are formed according to a process control principle;

Particularly, a logic diagram having the time sequential characteristic and reflecting operating states of the protective relay system in a visual manner is dynamically displayed.

What can be seen from the technical solution mentioned above is as follows. Under normal operation of the protective relay system, the visual dynamic monitoring method for operating states of the protective relay system according to a preferred embodiment of the present invention is capable of showing the operating states of the protective relay system, which accord with the protection principle designed and have a time sequential characteristic. Thus, technicians are capable of visually observing whether each component involved in the protective relay system is in good condition. Moreover, the reliability of the protective relay system is improved.

The visual dynamic monitoring method for operating states of the protective relay system is capable of increasing a visual dynamic monitoring function of the operating states of the protective relay, under the premise of not changing the reliability of the relay protecting; providing an important technical support for avoiding the expansion of a power system disturbance due to mal-operation of a protective relay system, and improving the reliability of a power system.

These and other objectives, features, and advantages of the present invention will become apparent from the following detailed description, the accompanying drawings, and the appended claims.

### BRIEF DESCRIPTION OF THE DRAWINGS

In order to illustrate a technical solution according to a preferred embodiment of the present invention more clearly, brief introduction is illustrated on an accompanying drawing which is required in a description of the preferred embodiment. Obviously, the accompanying drawing is only some preferred embodiments recorded by the present invention. And ordinary skilled persons in the art are capable of obtaining other drawings according to the accompanying drawing without creative work.

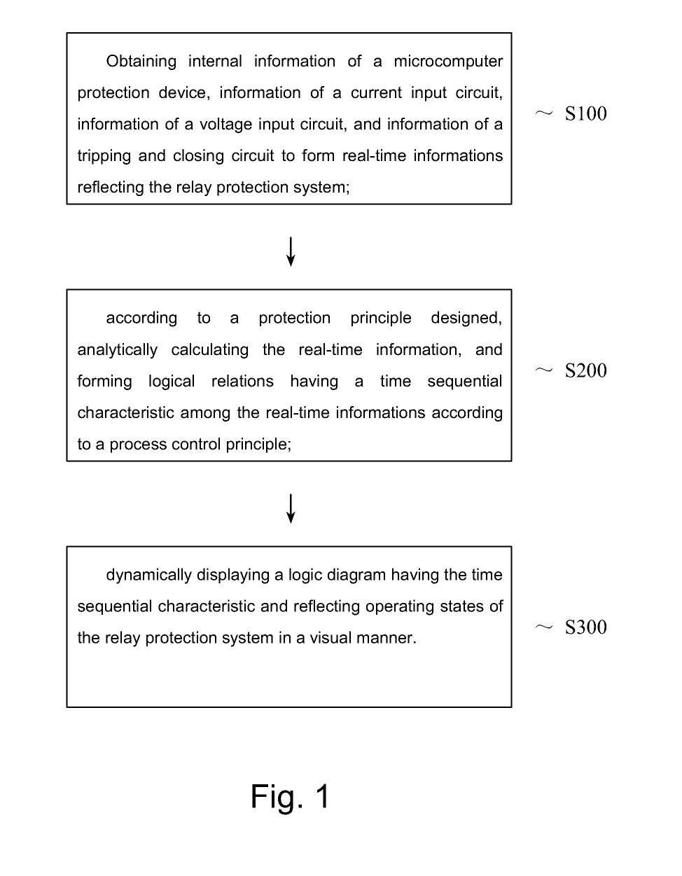

The FIG. 1 is a flow chart of a visual dynamic monitoring system for operating states of a protective relay system according to a preferred embodiment of the present invention.

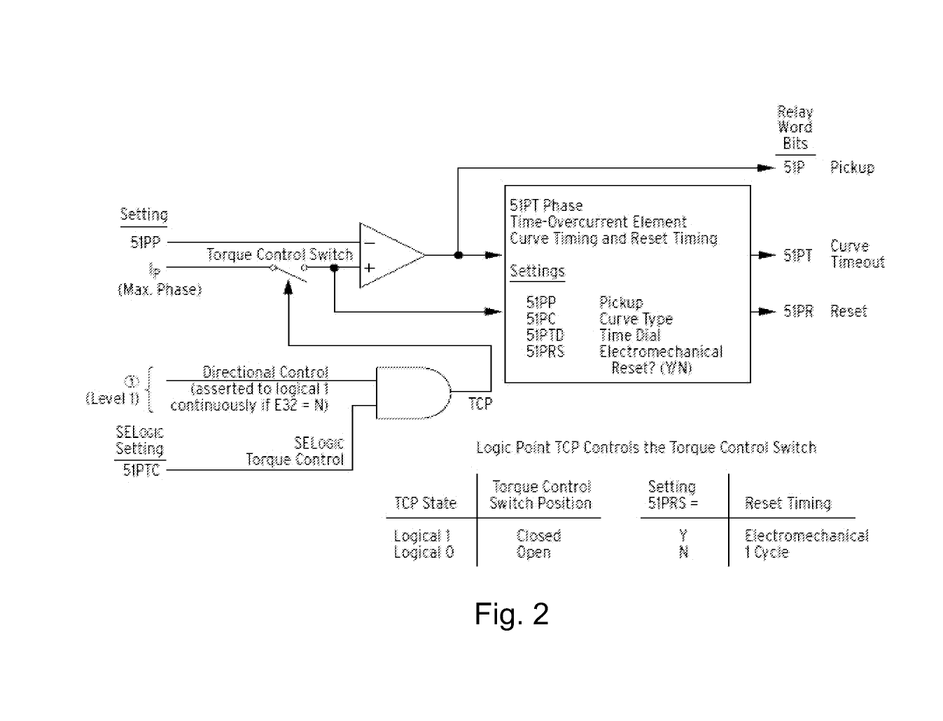

The FIG. 2 is a schematic view of logical relations of real-time informations of the visual dynamic monitoring system for operating states of a protective relay system according to the preferred embodiment of the present invention.

### DETAILED DESCRIPTION OF THE PREFERRED EMBODIMENT

In order to help the skilled persons to fully understand technical solutions of the present invention, combined with the accompanying drawing, clear and complete descriptions of a technical solution is provided according to a preferred embodiment of the present invention as following. Apparently, the preferred embodiment described is only part of, rather than all of, preferred embodiments of the present invention. Based on the preferred embodiment of the present invention, any other embodiments obtained by ordinary skilled persons and without creative work are within a protection scope of the present invention.

### Embodiment 1

The figure is a flow chart of a visual dynamic monitoring system for operating states of a protective relay system according to a preferred embodiment of the present invention.

Referring to the figure, a visual dynamic monitoring method for operating states of a protective relay system comprises steps as following:

S100: obtaining information of a voltage input circuit and current input circuit of the protective relay system, internal information of a relay device, and information of a tripping and closing circuit, wherein

the information of the current input circuit and as well as voltage input circuit are collected by a collector specialized, and are output to a dynamic monitoring device via a communication port of the collector,

internal hardware & software logic states of computer based relays are read from a communication port of the relays by the dynamic monitoring system via a communication network, and

the information of the tripping and closing circuit is collected by the collector specialized, and is output to a dynamic monitoring device via the communication port of the collector,

wherein after obtaining the information of the voltage input circuit of the protective relay system, the information of the current & voltage input circuit and the internal logic hardware & software information as well as the information of the tripping and closing circuit of the protective relay system, complete and real-time information are formed;

S200: processing an analytical calculation, wherein for the real-time information which reflects operating conditions of the protective relay system completely, according to a designed protection principle a Boolean calculation is implemented, in such a manner that coupling of calculating information input and the designed protection principle is realized, wherein according to a process control principle, logical relations having a time sequential characteristic are formed among the real-time information with a result based on the analytical calculation,

wherein the dynamic monitoring device designs an algorithm of the protection principle according to the process control principle, and the key lies in that a calculated result is capable of realizing logical relations, which accord with the protection principle designed and have a time sequential characteristic, among real-time information;

S300: dynamically displaying a logic diagram having the time sequential characteristic and reflecting operating states of the protective relay system in a visual manner,

wherein according to a result of operating states of the protective relay system formed by the analytical calculation, the dynamic monitoring device dynamically displays operating states and action behaviors of the protective relay system, so as to realize transparent representing of an operating principle of the protective relay, in such a manner that the operating states of the protective relay system can be judged visually in real time,

wherein adopting a visual technical measure, the monitoring system dynamically displays information of operating states of the protective relay system having a time sequential characteristic.

According to the preferred embodiment mentioned above, the visual dynamic monitoring system for operating states of a protective relay system provided by the present invention is capable of showing the operating states of the protective relay system which accord with the designed protection principle and have a time sequential characteristic. Thus, protection technicians and operation staffs are capable of visually observing healthy conditions of the protective relay system and knowing the correctness of the relay and a secondary circuit. The visual dynamic monitoring system for operating states of a protective relay system provided by the present invention is in favor of improving the reliability of the protective relay system.

Particularly, in the step of analytically calculating the above mentioned real-time information, based on the designed protection principle, and forming logical relations having a time sequential characteristic among the real-time information, the real-time information of the protective relay is:
EN,INST,A,B,C,N,RS,LO (panel indicator),
51P1P,51Q1P,51N1P,51P1T,51Q1T,51N1T,*,RB1,
50P1P,50Q1P,50N1P,50P1T,50Q1T,50N1T,50P1H,50N1H,
51P2P,51Q2P,51N2P,51P2T,51Q2T,51N2T,*,RB2,
50P2P,50Q2P,50N2P,50P2T,50Q2T,50N2T,50P2H,50N2H,
87U1,87U2,87U3,87U,87R1,87R2,87R3,87R,
2HB1,2HB2,2HB3,5HB1,5HB2,5HB3,87BL,RB3,
TH5P,TH5T,PDEM,NDEM,QDEM,TRP1,TRP2,TRP3,
OC1,OC2,CC1,CC2,IN1,IN2,1,2,
MTU3,MTU2,MTU1,Y,XT,X,
51P1R,51Q1R,51N1R,51P2R,51Q2R,51N2R,*,RB4,
*,*,*,ALARM,OUT1,OUT2,OUT3,OUT4 (output contact),

wherein referring to the accompanying drawings, analytically calculating the real-time information based on the designed protection principle means forming the logical relations among the real-time information points.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A visual dynamic monitoring method for operating states of a protective relay system, which is applied to the computer based relay comprising:
collecting information of a voltage input circuit and a current input circuit of the protective relay system, and internal hardware & software of a relay, as well as a tripping and closing circuit, to obtain real-time information completely reflecting operating states of the protective relay system;
analytically calculating the real-time information mentioned above according to the designed protection principle, and forming logical relations having a time sequential characteristic among the real-time information with a result by the analytically calculating; and
visually displaying the operating states of the protective relay system, so as to provide a supporting data for implementing an evaluation of the operating states of the protective relay system.

2. The visual dynamic monitoring method, as recited in claim 1, wherein the information of the current input circuit and the voltage input circuit are collected by a collector specialized, and are output to a dynamic monitoring device via a communication port of the collector.

3. The visual dynamic monitoring method, as recited in claim 2, wherein internal logic states of the computer based relay are obtained by the dynamic monitoring system via a communication network to read from a communication port of the the computer based relay.

4. The visual dynamic monitoring method, as recited in claim 3, wherein the information of the tripping and closing circuit is collected by a collector specialized, and is output to a dynamic monitoring device via the communication port of the collector.

5. The visual dynamic monitoring method, as recited in claim 1, wherein according to a result of operating states of the protective relay system formed by the analytical calculation, the dynamic monitoring device dynamically displays operating states and action behaviors of the protective relay system, so as to realize transparent representing of an operating principle of the protective relay, in such a manner that the operating states of the protective relay system can be judged visually in real time.
